(19) United States
(12) Patent Application Publication
(10) Pub. No.: US 2023/0079139 A1
(43) Pub. Date: Mar. 16, 2023

(54) WORKFLOW TRACKING AND ANALYSIS SYSTEM

(71) Applicant: Target Brands, Inc., Minneapolis, MN (US)

(72) Inventors: BRIAN JONES, Peoria, AZ (US); DANIEL HANSON, Minneapolis, MN (US); DANIEL BIRCH, Minneapolis, MN (US); ADITYA SINGH, Minneapolis, MN (US)

(21) Appl. No.: 17/944,034

(22) Filed: Sep. 13, 2022

Related U.S. Application Data
(60) Provisional application No. 63/244,063, filed on Sep. 14, 2021.

(51) Int. Cl. G06Q 10/06

(52) U.S. Cl. CPC G06Q 10/06393

(57) ABSTRACT

Methods and systems for capturing fine-grained workflow performance data, and generating user interfaces for analyzing such fine-grained workflow performance data to adjust operational parameters and assumptions within one or more nodes of an enterprise supply chain, are disclosed. A dataset including the time period spent on each scan-level event, a volume processed by the user during a particular task at the enterprise node, a total time spend on the plurality of events at the enterprise node, and a volume processed by enterprise node, is generated and used in such analyses.

### CROSS-REFERENCE TO RELATED APPLICATIONS

The present disclosure claims priority from U.S. Provisional Patent Application No. 63/244,063, filed on Sep. 14, 2021, the disclosure of which is hereby incorporated by reference in its entirety.

### TECHNICAL FIELD

The present disclosure is generally directed to a workflow tracking and analysis platform useable to maintain a dataset, as well as to provide tools for workflow performance analysis.

### BACKGROUND

Common expectations (CEs), such as engineered labor standards, are used in business to measure productivity. Generally, engineered labor standards define the time necessary for a trained worker, working at an acceptable pace, under capable supervision, and experiencing normal fatigue and delays, to do a defined amount of work of specified quality when following a predetermined method. CEs are traditionally assessed annually or bi-annually, and re-evaluated at those times. Re-evaluation can be used to determine performance for both the worker and the business.

In existing solutions, manual entry of the time required for each employee to accomplish discrete tasks is performed. Such manual entry of time is required to enable any level of detailed analysis of the effectiveness of common expectations. This often leads to discrepancies and inherent errors. For example, in some instances, employee workers are required to enter times when a particular task is started and completed. Because employees often overlook this tracking task, the data collected by manual time start/completion entries is inherently unreliable, and often noisy. Furthermore, employee workers often elect to only enter a start time and a completion time, and employee time outside of a discrete task timeframe is not accurately captured as part of overall common expectations. For example, time taken for training, breaks, extra (but necessary) tasks such as corrective action, or various other unpredictable events may not accurately be captured or reflected in captured data.

Because of the inherent inaccuracy of this detailed task-level data, often sets of CEs are assessed not at the task (line) level, but instead at an overall shift-level. That is, a particular user (working employee) will be assessed based on total work performed (in terms of volume) over a shift, with common assumptions made regarding break times or process flows across locations that may include common types of tasks.

This issue of inaccurate task (e.g., line) level data is further exacerbated by the fact that common expectations (CEs) are not regularly updated for individualized tasks. For budget purposes, historical line item CE productivities within a particular process path have scaled together (up or down). The primary reason for this methodology is that hours are entered only at the process path level (i.e., for an overall process path) and thus no indicators of actual performance at the line item level (i.e., for sub-portions of a process path) have existed. While CEs may be adjusted more frequently to adjust for perceived changes in productivity, such adjustments are often made based on top-level productivity observations (i.e., again at the aggregate shift level across a large number of worker users), rather than individual line-level productivity improvements. Because specific productivity improvements often occur based on granular changes in process (e.g., by changing specific volume levels, timing of volume, presentation of volume, and density), any such improvements in process are not often accurately attributed at the line level, but instead are assume as being achieved over an entire process path. Therefore, reengineering of process paths does not easily account for the ways in which individual line level productivity improvements have been achieved. As such, planning, budget, and resource allocation decisions made based on CEs may be misleading or inaccurate.

### SUMMARY

In summary, the present disclosure relates to methods and systems for capturing fine-grained workflow performance data, and generating user interfaces for analyzing such fine-grained workflow performance data to adjust operational parameters and assumptions within one or more nodes of an enterprise supply chain. A dataset including the time period spent on each scan-level event, a volume processed by the user during a particular task at the enterprise node, a total time spend on the plurality of events at the enterprise node, and a volume processed by enterprise node, is generated and used in such analyses.

In an example aspect, a method of assessing productivity of a task at an enterprise node is disclosed. The method includes receiving user identifying information including at least a location and a user identification, and receiving user scan-level data of a plurality of events, the scan-level data including an event attribute identifier and a time stamp, where the time stamp indicates when an event of a plurality of events began. The method further includes determining an end time of each one of the plurality of events, where the end time is a presumed start time of a subsequent event, and determining a time period spent on each event. The method also includes outputting a dataset including the time period spent on each event, a volume processed by the user at the enterprise node, a total time spend on the plurality of events at the enterprise node, and a volume processed by enterprise node.

In another example aspect, a system for analyzing workflow efficiency within an enterprise supply chain node is disclosed. The system includes a computing system including a data store, a processor, and a memory communicatively coupled to the processor. The memory stores instructions executable by the processor to: access a dataset including scan level data and enriched data, the dataset including a time period spent on each event of a plurality of events, a volume processed by a user at an enterprise node, a total time spend on the plurality of events at the enterprise node, and a volume processed by enterprise node; select an enterprise node at which common expectations for performance of each of a plurality of different tasks are to be set from among a plurality of nodes within an enterprise; perform a right-sizing of common expectations during a current year for each of the plurality of different tasks based on the dataset including the determined end time or time period; set a location-specific performance target; and apply the location-specific performance target to each of the right sized plurality of different tasks.

In a further aspect, a non-transitory computer-readable medium comprising computer-executable instructions, which when executed by a computing system cause the computing system to perform: receiving user identifying information including at least a location and a user identification; receiving user scan-level data of a plurality of events, the scan-level data including an event attribute identifier and a time stamp, wherein the time stamp indicates when an event of a plurality of events began; determining an end time of each one of the plurality of events, wherein the end time is a presumed start time of a subsequent event; determining a time period spent on each event; outputting a dataset including the time period spent on each event, a volume processed by the user at the enterprise node, a total time spend on the plurality of events at the enterprise node, and a volume processed by enterprise node.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example environment useful in a workflow analytics system.

FIG. 2 illustrates an example detailed supply chain task flow in which a workflow analytics system can be implemented.

FIG. 3 is an example schematic block diagram of a workflow analytics system according to an example embodiment of the present disclosure.

FIG. 4 illustrates an example block diagram of a computing system useable to implement aspects of the present disclosure.

FIG. 5 is an example flowchart of a method for capturing scan-level data to impute task start and end times for individualized tasks, in accordance with example embodiments described herein.

FIG. 6A is an example dataset of captured scan data from a particular user that may be used to impute task start and end times, in an example embodiment.

FIG. 6B is an example dataset of captured scan data from a plurality of users that may also be used to impute task start and end times, in a further example embodiment implemented within a supply chain environment.

FIG. 7 is an example method of generating an analysis interface based on the enriched scan-level dataset captured using the workflow analytics system of the present disclosure.

FIG. 8 is an example chart showing common expectation setting using a previous process.

FIG. 9 is an example flowchart of a method of setting common expectations across locations within a supply chain at a line, or task-specific, level.

FIG. 10 is an example chart showing right-sizing of common expectations in a previous year based on actual data, as well as relative volumes of items processed according to particular tasks that may be used in weighting the effect of that task on overall location performance.

FIG. 11 is an example chart showing modification of the right-sized common expectations for a subsequent year.

FIG. 12 is a first example analysis interface generated by a workflow analytics system, useable to display location-level performance data.

FIGS. 13A-B are graphs displayable within the user interface of FIG. 12 showing changes in goals based on use of an improved dataset as described herein.

FIG. 14 is a graph displayable within the user interface of FIG. 12 showing a finely-grained analysis of tradeoff between individual item identities and number of cartons to determine whether automated or manual dock assignment is optimal.

FIGS. 15A-E illustrate ordered graphs of relative performance of various tasks across locations having differing levels of break time offered.

FIG. 16 is a graph depicted within the user interface of FIG. 12 showing advantages of repeated items appearing within a particular line (task) item.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

In example embodiments, a workflow analytics system is provided that captures and provides for analysis an analytical dataset (ADS) containing a list of governed historical productivity attributes. The system described herein uses aggregated and enriched scan level data captured in a manner that is incidental to, but required by, the tasks performed at the task, or line, level, in order to provide increased granularity and accuracy as to both volume of work performed and hours required to perform that work. As a result, individualized line item productivity performance measures are viewable with the data collected, well below the hours entry points at the process path level that is traditionally collected. Furthermore, particular analyses may be performed that would not historically be possible at the process path level.

In example aspects, the workflow analytics system uses time stamps captured to stitch together actual volume processed by team members and the duration of time it took to process at the line item level. In particular aspects, the time stamps are associated with known work units and captured inferentially (i.e., not requiring a separate data capture step by an employee worker at the line level) so work volume and time may be collected without separate, explicit entry by that worker. These time stamps are then analyzed and stitched together to provide a line level view of the work performed. As part of this stitching process, the workflow analytics system can also account for, and exclude, time spent doing unproductive tasks like breaks, team meetings, downtime, etc. based on predetermined rules and logic. In addition, specific events can be flagged for exclusion where wide variability occurs such as first and last scans which include startup/walk time that make those events not indicative of repeatable productivity expectations. As a result, the workflow analytics system productivities in most cases are higher than are typically captured, since significant noise and unproductive task time can be excluded. Nevertheless, the platform and system described herein has the ability to access and analyze all events to ensure the population of data appropriately matches historical worker time entry volumes and hours.

In the context of the present disclosure, individual line item work entries that may be subject to data capture and/or analysis by the workflow analytics system of the present disclosure may be performed within an overall workflow defined as part of a supply chain architecture of established retail sites, established flow centers useable to stage items for delivery to the retail sites, established receive centers for receiving product from vendors and redistribution to those flow centers, and established hauling routes between and among the receive centers, retail sites, and flow centers, each of which are also herein referred to as “nodes.” Additional details regarding such a supply chain arrangement are shown in U.S. Patent Pub. No. 2019/0259043, entitled ‘Method and System for Supply Chain Management, the disclosure of which is hereby incorporated by reference in its entirety.

As generally recognized within such a supply chain environment, each node requires the movement of inventory. Aggregated and enriched employee worker scan level data provides more detailed information and higher level of granularity to monitoring productivity within the node and across nodes (including across like line level tasks at similarly-situated nodes). Measuring productivity includes determining both volume and time spent.

### I. Workflow Data Capture and Processing Environment

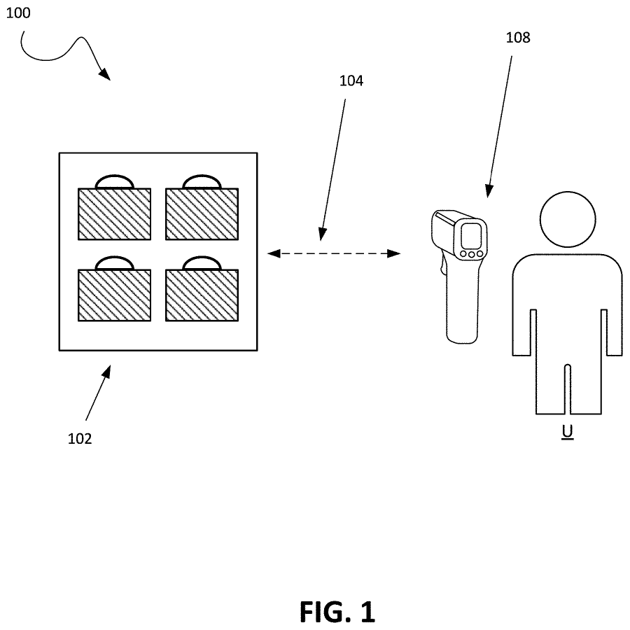

FIG. 1 illustrates an example environment 100 in which the workflow analytics system is used. In the example environment 100 shown, an employee worker (seen as user U) scans 104 inventory 102. The scanning 104 represents any type of daily event a user U encounters during the workday at an enterprise node. For example, in one possible embodiment, the scanning 104 may be a scanning process performed in a warehouse, such as a receive center or a flow center, used by the user U to capture a carton movement between locations in the warehouse. In particular examples, the scanning 104 may be a scanning of a carton or item code (e.g., a product identifier) that is indicative of a carton pull event. In other examples, various other types of scan events indicative of other line level tasks are captured.

In the example environment 100 shown, the user U is using a scanning tool 108. The scanning tool 108 is representative of any electronic computing device that may be used to collect data. The electronic computing device may be a scanning device, a mobile POS device, a smart phone, tablet, or other similar electronic computing device. The electronic computing device is capable of ingesting information such as, at least event attribute identifiers and time stamps. The electronic computing device, and any scanning tool associated therewith, is capable of connecting to a server device over a network. The network and be any type of wireless network, wired network, and cellular network, including the Internet. The electronic computing device can capture the event level data and send it to the server device first further processing and storage.

Such scan events are generally captured as part of an item movement process within a supply chain node or across supply chain nodes, and are performed at the start of a line level task as an initial step of any specific line level task. For example, a scan of a particular item may return to the user U a particular set of instructions regarding how to handle a particular item or task associated with the item, such as a particular item breakdown (e.g., from case or carton level to individual item level), movement to another area within a particular node, or any other type of task. Notably, while in example aspects of the data collection process this initial scan is required, rather than relying on a second scan at the end of the same task by the same user U to indicate completion of a task, in some instances a next initial scan by the same user U can be used to inferentially determine that the first task has been completed. In other examples, a further scan of the same item by a different user at a later time is used to inferentially conclude that the previous task has been completed within the time between scans of the same item by different users. Such inferences may be used to supplement or enrich captured scan-level, task-level data. This has the advantage of removing an additional step or requirement by the user U to indicate completion of a task. Since available information explicitly indicating completion of a task is at best noisy and at worst unreliable, as discussed below, task completion is otherwise inferred by a scan at the start of a subsequent or downstream task, and can be adjusted based on known exigencies (e.g., breaks, beginning/end of day inefficiencies) to obtain a generalized efficiency measure for a particular task. Example scan level events can include, for example, a pull verification event, a container build event, a load container event, a trailer unload event, a close carton event, an open carton event, a complete pick event, a split event, a receive event, and a put away event.

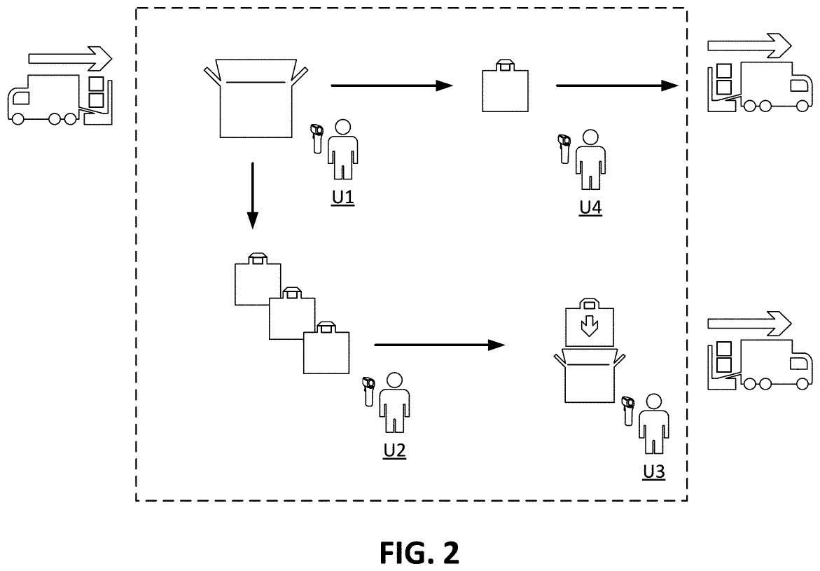

Referring now to FIG. 2, a simplified schematic diagram of an example node 200 within a supply chain is depicted. In this example, the node 200 may represent a receive center or flow center, e.g., a warehouse at which items are received, processed and rerouted along any of a number of different supply chain routes, and delivered for transport along various transportation lanes to, e.g., other warehouse or retail locations. The example diagram at node 200 involves a number of employee workers, designated as users U1-U4. Other configurations or numbers of users could be involved in a given process at a node 200.

In the example shown, the node 200 receives shipments 202 of items at a first location within the node 200 (e.g., at a receiving dock). The items received via shipment 202 may be scanned for initial receipt by a user U1. The initial scan may be a scan of a bar code and/or QR code associated with a particular item, carton, pallet, etc. of items, and may result in an instruction being presented to the user U1 as to routing of one or more of the items included within the shipment. In the example shown, the user U1 may pass items to a plurality of different locations. In a simplified example, the user U1 may be instructed to depalletize items and deliver items (e.g., based on the identity of the item scanned) to a first flow or a second flow.

In a first flow, the user U1's line level task would result in some operation performed on an item or items. Upon completion of the line level task, the user U1 would deliver some portion of processed items to a downstream location within a overall task flow. In the example shown, a set of items may be provided for further processing by a second user U2. The second user U2 may process the items, and pass items to a third user U3, for example for packaging items for delivery to an outbound delivery channel 204a. In a second flow, the user U1's line level task would result in delivery of an item to a downstream location where user U4 would provide for the processing, for delivery to an outbound delivery channel 204b. In the example shown, individualized items may be provided for processing by a further user U4.

In this example flow, either user U2 or user U4 would begin their task by scanning the items received at the completion of the task performed by the user U1, and therefore it can be inferred that the task performed by the user U1 on the particular items has been completed. For example, if user U1 is tasked with dissembling a carton of items into individualized items and delivery of some of those items to either user U2 or user U4, once user U1 has completed their task and started a new task (e.g., indicated by a new scan event by user U1), it can be assumed that user completed his or her earlier task. Additionally, once one of those dissembled items has been received by another user and scanned by that user, it can be assumed, in some instances, that user U1 has completed their task. In other instances, it may be inferred that user U1 has completed their task only after all items included in a scanned collection of items (e.g., a carton) have been scanned at downstream locations. Nevertheless, regardless of the specific time at which user U1 has been determined to have completed their task, that user does not need to perform an additional task completion notification process (e.g. a further scan or confirmation upon completion), thereby simplifying the reporting process for that user.

It is noted that within a supply chain as discussed herein, there may be many nodes that require performance of analogous tasks. Accordingly, line level tasks may be compared across nodes to determine relative efficiencies of those line level tasks across an entire supply chain

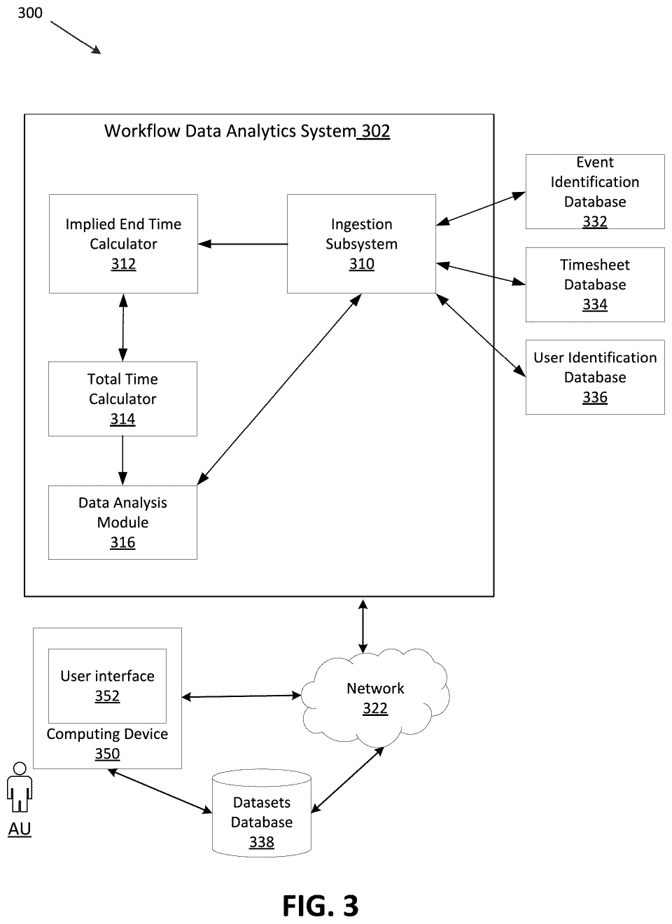

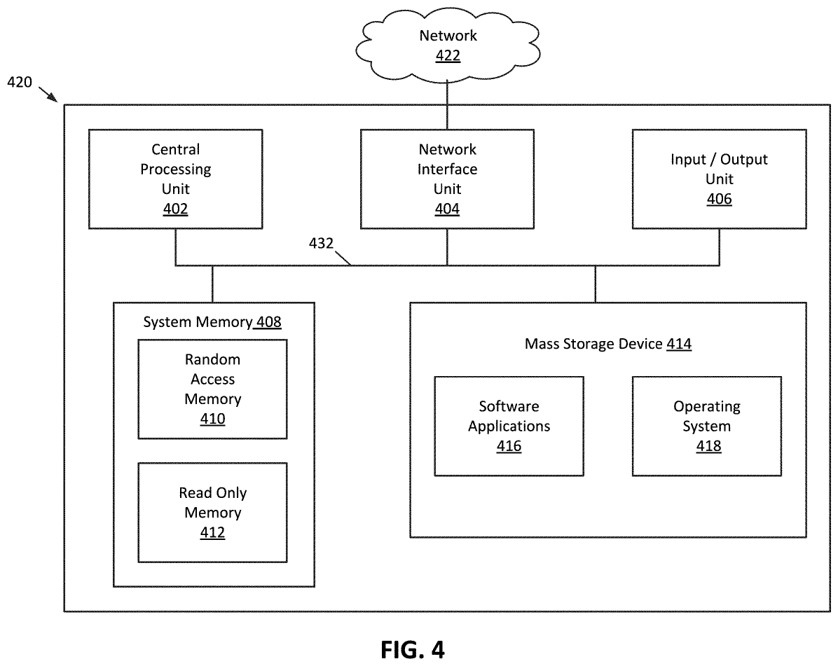

FIG. 3 illustrates a schematic diagram of an example system 300 for implementing workflow analytics system 302. The workflow analytics system 302 can be implemented in the form of a software tool executed on a computing device, such as the device seen in FIG. 4. Components of the workflow analytics system include an ingestion subsystem 310 and implied and time calculator 312, a total time calculator 314, and a data analysis module 316.

In the example shown, the ingestion subsystem 310 receives inputs from a plurality of databases, such as an event identification database 332, a timesheet database 334, and a user identification database 336. The event identification database 332 maintains, at least, inventory information across a plurality of inventory items across the enterprise system. For example inventory information may include a size and weight of a particular inventory item. In another example, inventory may be described in terms of eaches (individual items), cartons, or pallets. In another example, inventory may be described solely in terms of weight (e.g., in the case of bulk items, or grocery items).

The event identification inputs are received by the event identification database 332, which is called by an event identification API after receiving a request from the ingestion subsystem 310. Further, the event identification database 332 can receive inputs from the electronic computing device, such as the scanner 108.

The timesheet database 334 maintains, at least, clock in and clock out information for a plurality of users. Further, the timesheet database 334 can maintain exempt event information, such as breaks, meetings, and idle time. The timesheet database inputs are received by the timesheet database 334, which is called by a timesheet API after receiving a request from the ingestion subsystem 310.

The user identification database 336 maintains a user identification corresponding to an employee who is scanning scan-level data of an event. For example, user identification may include the username, the location of the user, and the job title of the user. Other user identification information may include information regarding the particular task-level data assigned to the user for the portion of time during which scan events are collected.

The user identification inputs are received by the user identification database 336, which is called by a user identification API after receiving a request from the ingestion subsystem 310.

In response to receiving the inputs, the ingestion subsystem 310 provides the data to the implied time calculator 312 and/or the data and analysis module 316. The implied time calculator 312 receives a start time for each event. In example implementations, the end time of each event is determined by receiving the start time of a subsequent event, and presuming that the start time of the subsequent event is also the end time of the previous event. The start time of the subsequent event can be, for example, a start time of a subsequent event by the same user (indicating that the user completed the previous task), or can be a start time of a subsequent event by a different user on the same item (also indicating that the previous user completed the previous task in a sequence of tasks to be performed on the item).

The time for each event determined by the implied end time consider 312 is supplied to the total time calculator 314. The total time calculator 314 determines the total time spent on each event. The total time calculator 314 can also determine the total time spent on a per day basis, per user basis, per node basis, per year basis, and other similar larger time frames.

The data analysis module 316 receives inputs from the ingestion subsystem 310 and the total time calculator 314, and generates one or more analyses to develop one or more data sets for visualization and assessment of workflow productivity. The data set includes, at least, a time period spent on each event, a volume processed by the user at the enterprise node, a total time spent on the plurality of events at the enterprise node, and a volume processed by the enterprise node. This information can be presented to a user interface 352 via the network 322.

The output determined by the workflow analytics system 302 is displayable via a user interface 352 of a connected computing device 350 via the network 322. The output provided by the workflow analytics system 302 is also stored at the data sets database 338. The data sets database 338 can be accessed by the network 322 by the workflow analytics system 302 and the computing device 350. The user interface 352 can be viewed by an administrative user of the workflow analytics system 302.

The workflow analytics system 302 communicates with a computing device 350 through a network 322. The network 322 can be any of a variety of types of public or private communications networks, such as the Internet. The computing device 350 can be any network-connected device including desktop computers, laptop computers, tablet computing devices, smartphones, and other devices capable of connecting to the Internet through wireless or wired connections. Example user interfaces displayable to an administrative user (e.g., user AU) to present various analyses of workflows are described in Part II, below.

The collected information can be stored in a blockchain storage device (not shown), which can be an electronic computing device or plurality of electronic computing devices. The block chain data storage device can comprise a plurality of distributed, peer-to-peer storage devices, for example server computing devices, that can store the event level data. An example block chain data storage device is a digital ledger that stores event details, such as event attribute identifiers, timestamps, and user identifying information. The block chain storage data device can receive block chain entries, or blocks, and store the associated data. The block chain storage device can determine whether to store the data in a new block. Such a blockchain storage device may be implemented within storage of one or more computing devices, such as the computing device seen in FIG. 4, below.

Referring now to FIG. 4, an example block diagram of a computing system 420 is shown that is useable to implement aspects of the workflow analytics system 302. In the embodiment shown, the computing system 420 includes at least one central processing unit (“CPU”) 402, a system memory 408, and a system bus 432 that couples the system memory 408 to the CPU 402. The system memory 408 includes a random access memory (“RAM”) 410 and a read-only memory (“ROM”) 412. A basic input/output system that contains the basic routines that help to transfer information between elements within the computing system 420, such as during startup, is stored in the ROM 412. The computing system 420 further includes a mass storage device 414. The mass storage device 414 is able to store software instructions and data.

The mass storage device 414 is connected to the CPU 402 through a mass storage controller (not shown) connected to the system bus 432. The mass storage device 414 and its associated computer-readable storage media provide non-volatile, non-transitory data storage for the computing system 420. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 402 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 420.

According to various embodiments of the invention, the computing system 420 may operate in a networked environment using logical connections to remote network devices through a network 422, such as a wireless network, the Internet, or another type of network. The computing system 420 may connect to the network 422 through a network interface unit 404 connected to the system bus 432. It should be appreciated that the network interface unit 404 may also be utilized to connect to other types of networks and remote computing systems. The computing system 420 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the computing system 420 can store software instructions and data. The software instructions include an operating system 418 suitable for controlling the operation of the computing system 420. The mass storage device 414 and/or the RAM 410 also store software instructions, that when executed by the CPU 402, cause the computing system 420 to provide the functionality discussed in this document. For example, the mass storage device 414 and/or the RAM 410 can store software instructions that, when executed by the CPU 402, cause the computing system 420 to receive and analyze inventory and demand data.

In accordance with the present disclosure, and in particular with respect to the computing device disclosed in FIG. 4, it is noted that in some instances, rather than direct execution of software instructions on computing hardware, a virtualization system may be implemented that is configured to host and execute software instructions within a virtualized environment. In such instances, a portion of an enterprise-wide pool of computing systems may be allocated for execution of software instructions on an as-needed basis, e.g., for scaling to accommodate execution of the data analysis tasks described below. Additionally, such processing tasks may be performed concurrently on separately-allocated virtual machines to assist with parallelization of the process described above.

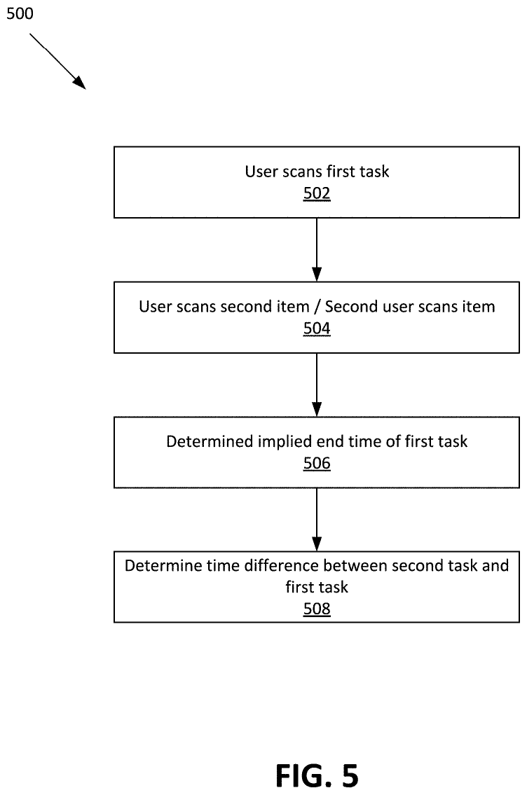

FIG. 5 is an example flowchart of a method 500 for capturing scan-level data to impute task start and end times for individualized tasks, in accordance with example embodiments described herein. In general, the method 500 may be performed using the workflow analytics system 302 of FIG. 3, as implemented on a computing system such as that seen in FIG. 4. Scan-level data generally includes scan event information identifying a task and a timestamp, as well as various other details of the event that may be relevant or able to be determined from the scan.

In general, the method 500 includes capturing a user scan of a item as part of a first task (step 502). The scan of the item may be performed by a particular user, and may be at the beginning of a task, such that the scan of the item indicates to the user a manner of handling of the item. For example, in response to a scan of a particular item being handled and processed by a user, the user may be able to retrieve, via a scanning device, information regarding particular handling or routing requirements for the item that was scanned. The item identity, timestamp of the scan, and instructions regarding tasks to be performed with respect to the item may form a part of the scan-level data for that item.

Following the scan of the item, the user may perform the one or more actions associated with the item or items. Generally, a time will elapse during the course of which the user will accomplish the task associated with a particular item or items. At some point in the future, the user may scan a second item associated with the second task, or a second user may scan the same item to determine a second task associated with that item (step 504). In either event, due to the user moving on to a different task and different item, or due to the item being subsequently processed by a different user, it may be inferred that the prior task has been completed. Accordingly, in the method 500, an implied end time of the first task may be assigned to the first task (step 506). Furthermore, a time to perform the task may be determined (step 508). This time may be based solely on a time difference between a start and imputed end time of a task, when considering singular tasks. However, this inferred time to perform a task may also be based on overall observations across similar tasks. For example, the inferred time to perform a task may be based on an average of times to perform a task while excluding typical “noisy” times of day that the task is performed, such as at the start or end of the day, or near a break time. In examples, a machine learning model or best fit model may be implemented to automatically select the subset of task execution times used to infer a general time to perform a task at a particular location.

Upon completion, captured transaction records at the task, or line, level may be enriched with task completion times, as well as other tasks details such that a data set may be created that utilizes start and inferred end times of tasks, user identities, task identifiers, and various other enriched data fields (optionally). Such information can also be enriched with average time to complete a task, as noted above.

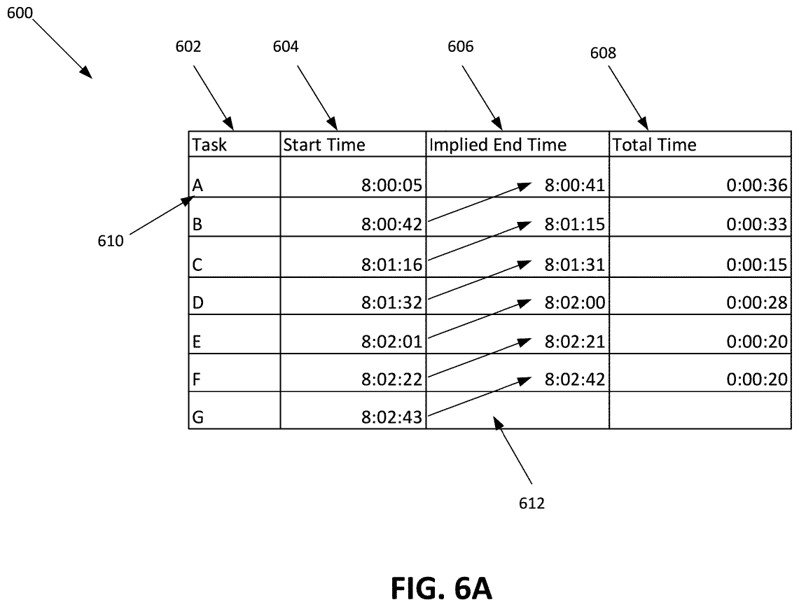

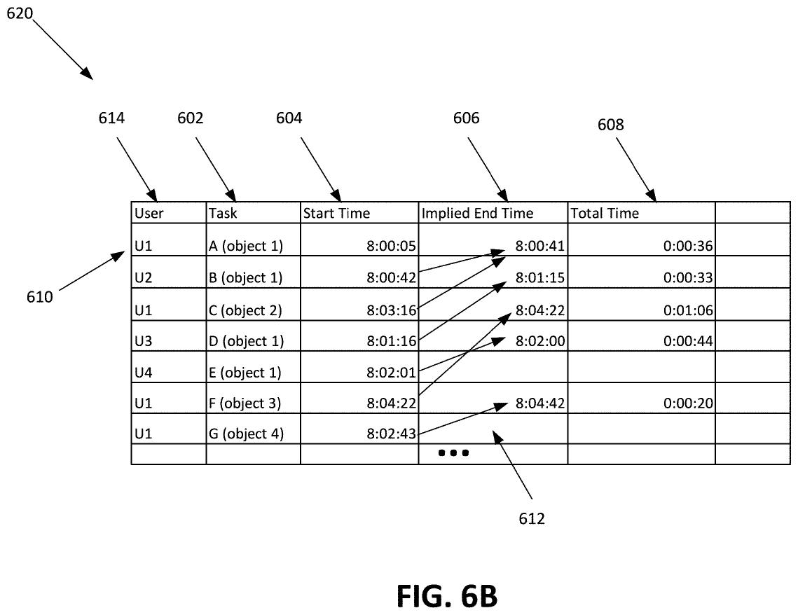

The inferential capture of end times is depicted in the data sets 600, 620 of FIGS. 6A-6B. FIG. 6A illustrates a first example data set 600 including a plurality of task entries 610. Each task entry 610 can include, for example, a task identifier 602 and a start time 604. The task identifier, and start time, may be received from scan data. In the example shown, some of the task entry 610 may also include an end time 606, as well as a total elapsed time for a given task 608. The end time 606 may be, for example, and implied and time that is determined based on a start time of a next task by the same user. As seen in the example, a set of subsequent start times are used to generate resultant end times using an inference calculation 612. The inference may also result in a total time elapsed being calculated based on a difference between a start time and an implied end time for a given task. Here, because individual tasks are being considered, the inferred end time and task completion time are based straightforwardly on subsequent task execution; however, as a greater number of scan level event data is gathered, a representative sampling of performance times for tasks may be developed, as noted above.

FIG. 6B illustrates a second example data set 620 that also includes a plurality of task entry 610. In this example, each task entry 610 may also include a user identity 614. Based on the addition of the user identity, as well as an identity of the object defined within the task identifier 602 (e.g. a task being defined as being an action to be performed on a particular item or group of items), implied end times 606 may be derived based on either a subsequent start time of the same user as to a different task (e.g. end time of task A being based on the third entry in the data set 620 in which user U1 starts task C) or based on a subsequent start time of a different user as to the same object (e.g. the end time of task A being based on the second entry in the data set 620 in which user U2 starts task B on object 1). As seen in this example, an earlier imputed time may result in selection between subsequent scan data from the same user or subsequent scan data from a different user as to the same object, with selection between those two scan data results resulting in the implied end time (e.g. typically being the earlier of the two scan data results). As above, although task execution times are generally shown as being discrete in the data set 620, the data set may also be enhanced by determining a representative distribution of execution times for a task and selecting a common expectation based on that representative distribution, as noted below.

Referring to FIGS. 1-6B generally, it is noted that the determination of an implied end time associated with scan data allows the workflow analytics system 302 described herein to capture more accurate task level data for subsequent analysis. This allows for a wider variety of possible assessments of workflow productivity, and underlies a number of newly available algorithms for assessment and alteration of workflow processes to improve overall physical productivity.

### II. Workflow Analytics Platform and Assessments Performed Using the Same

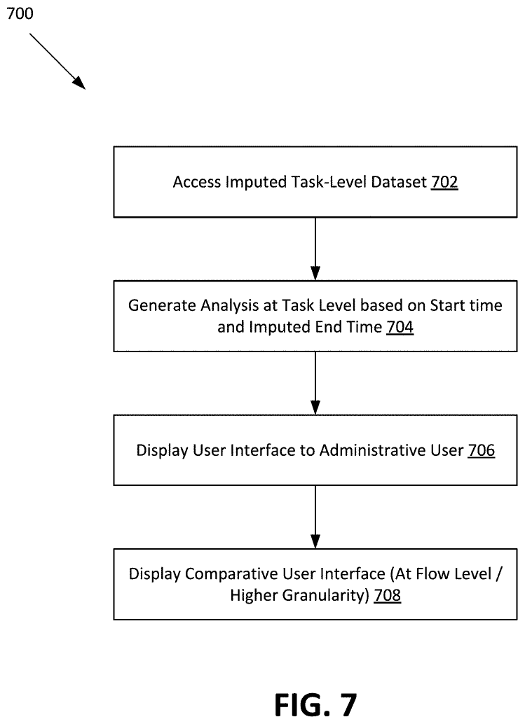

Referring now to FIGS. 7-13, an example method and user interfaces are displayed for analyzing and utilizing enriched workflow data. The specific user interfaces, and analyses performed, allow an administrative user (e.g., user AU of FIG. 3) to generate reports and/or assess performance of employee worker users, and generate actionable recommendations in response to such reporting. The graphical reporting, and in particular the manner in which granular data may be captured and displayed, provides greater accuracy of analysis and improved determinations of workflow efficiencies. This allows for improved downstream decisionmaking due to both increased (smaller-grain) granularity and increased overall accuracy.

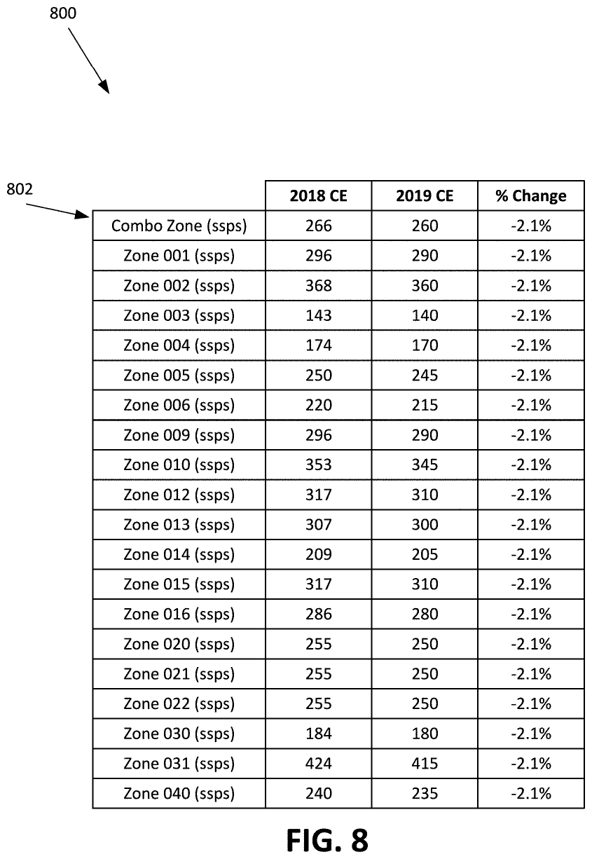

Referring to FIG. 7, a generalized method 700 of generating a workflow analytics display is provided which utilizes the enriched dataset obtained using inference-based assessment of scan data from task level workflows, as described above. The method 700 includes accessing the imputed task level data set (step 702), and generating an analysis at the task level based on start times and imputed end times of tasks (step 704). The analysis may take any of a variety of forms, such as those seen below in conjunction with FIGS. 8-13. However, it is recognized that the types or formats of analysis are not so limited.

In general, the analysis at the task level may include the assessment of a dataset to generate (if not already included in the dataset) a representative value or distribution of values for likely execution times for particular tasks. Based on such a representative distribution (and optionally, excluding noise due to variances occurring at particular locations, particular times of day, etc.), common expectations at the task level may be generated and applied in a weighted fashion (based, e.g., on task frequency) to map task level performance to node-level (overall location level) performance, and allow for comparative performance analysis at the task level across nodes.

In the example shown, the method further includes generating a display of a user interface that is presentable to an administrative user (step 706). The user interface may depict, for example, either the analysis based on the task level, enriched data set, or may be a comparative analysis (e.g., as in step 708) based on both a prior data set and the enriched data set to show changes in values that may occur based on using such enriched data. Examples of both types of user interfaces are provided below.

For further discussion of using such an enriched data set, FIG. 8 illustrates a pre-existing method of determining common expectations (CEs). Specifically, a chart 800 depicts CEs for the years 2018 and 2019 across a variety of zones within a particular type of layout of warehouse. Each zone 802 generally represents a particular task class or group of tasks that is performed within the warehouse (in this case, a bin packing zone). In this example a Bayesian Information Criterion (BIC) productivity rate is set based on comparative, undiluted performance relative to a prior year rate using qualitative factors around speed, safety, and quality. In this example, each packing zone has a next year rate established by changing a percentage by a predetermined amount. Accordingly, each of the zones has a same change in expected productivity. This is largely because actual productivity at the line level (at each his own) is not available or is susceptible to entry errors.

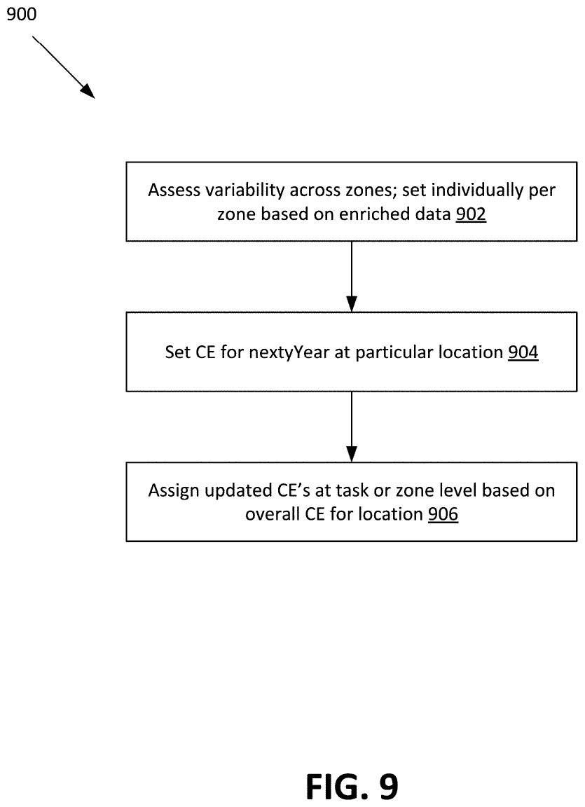

FIG. 9 illustrates a flowchart of a method 900 for calculating Common Expectations (CEs) using the enriched dataset described above. The method 900 may be considered a particular analysis generated, for example, at step 704 of the method 700 of FIG. 7, using, for example, the workflow tasks seen in FIG. 8.

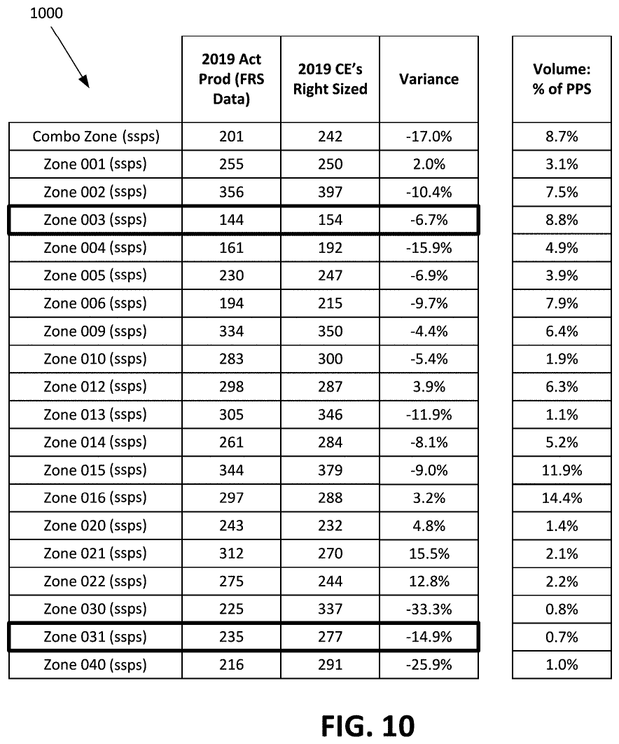

In the example shown, the method 900 includes normalizing current year common expectations by assessing volume and productivity variability across the various zones (step 902). This can include, for example, generating a weighting for each line item based on the volume and productivity variability across a selected set of locations. By doing so, a variance between actual productivity and the CE assigned to the task can be reduced on an absolute value basis greatly. An example illustrating this is seen in the chart 1000 of FIG. 10, in which individualized zones, once right-sized for the CE based on weighting for each line item based on volume and productivity variability based on the enriched data that is analyzed, have diverging CEs based on actual performance at that task or line level.

Continuing the method 900, once the common expectations are right-sized, a next year common expectation setting process can be performed (step 904) for a particular overall location by determining the BIC productivity rate for a selected set of tasks (e.g. a selected set of locations). For example, an automated building or a legacy (manual) building may each have separate CEs assigned, but which are a measure of overall productivity for that location. For example, an overall productivity change of 108% may be selected based on an observation or desire or budgeting of 8% performance improvement year-over-year for the particular location.

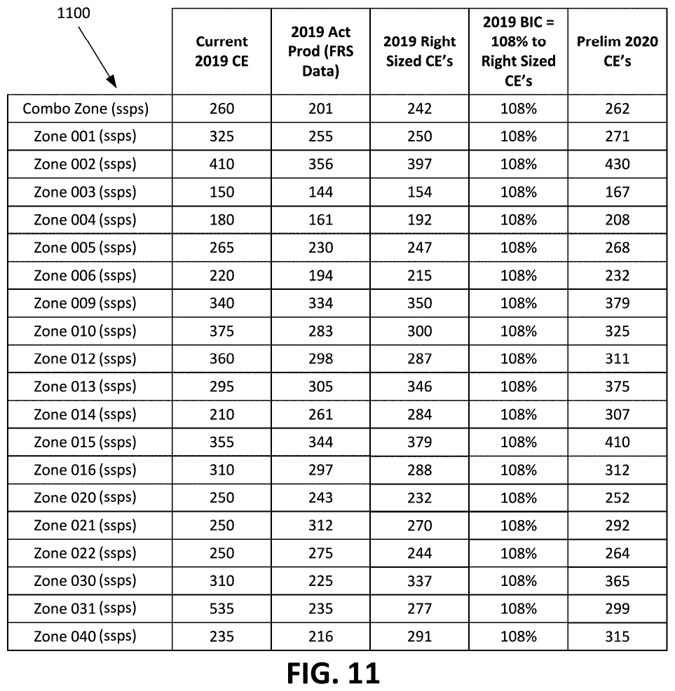

Once the next year common expectations are set for a particular location, each specific segment, or task may be analyzed and a BIC performance may be set for that segment or task, while maintaining an overall budgeted performance at 100% of the overall CE of the location (step 906). In particular, each individual task may be adjusted by the overall changed performance rate on a year-over-year basis, with the prior year right-sized CE adjustments at the task or line item level. Such an arrangement is seen in the chart 1100 of FIG. 11. In particular, because the enriched data set has fewer errors and finer granularity than existing data, each zone may have a CE that is adjusted independently of the other zones. This is particularly advantageous, because each zone is often associated with particular item identifiers or particular departments, or particular classes. Because each item has its own productivity, items having higher or lower productivity changes may result in changes in productivity that are unequal across zones.

In example embodiments, a dilution may be layered back onto the preliminary CEs to achieve a total goal in terms of hours reduction or other change in performance in the event that the BIC performance adjustment does not achieve a desired overall performance.

Although described in the context of a packing operation that is performed across a number of different lines within a given warehouse and across warehouses, it is recognized that a similar analysis may be performed in different locations within an overall supply chain environment, including other locations within a warehouse. For example, packing, warehouse poles, break pack poles, or other tasks may be individually assessed for overall efficiency and setting of performance metrics.

In example embodiments, to establish a comparative relationship between zones within a given warehouse location, a subset of overall building locations may be chosen to establish a relationship between these zones. This may avoid the possibility that, at a particular location, unique aspects of a building may result in undue weight on a particular zone or line at that building.

Still further, as adjusted CEs are determined for particular lines, in some examples the adjustment for the particular line or task may be capped at a predetermined amount to avoid significant divergence between past and future approaches. This has the potential impact of, at least in a short-term (over a next one or more years) reducing the accuracy of the generated using enriched data CEs by tying those CEs to legacy, inherently inaccurate values, but the advantage of improved confidence by planning organizations.

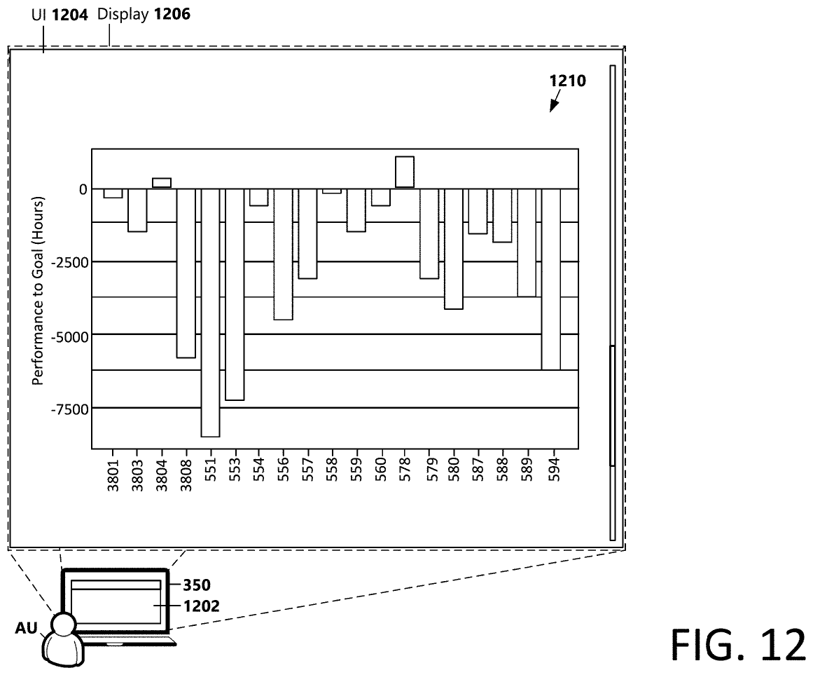

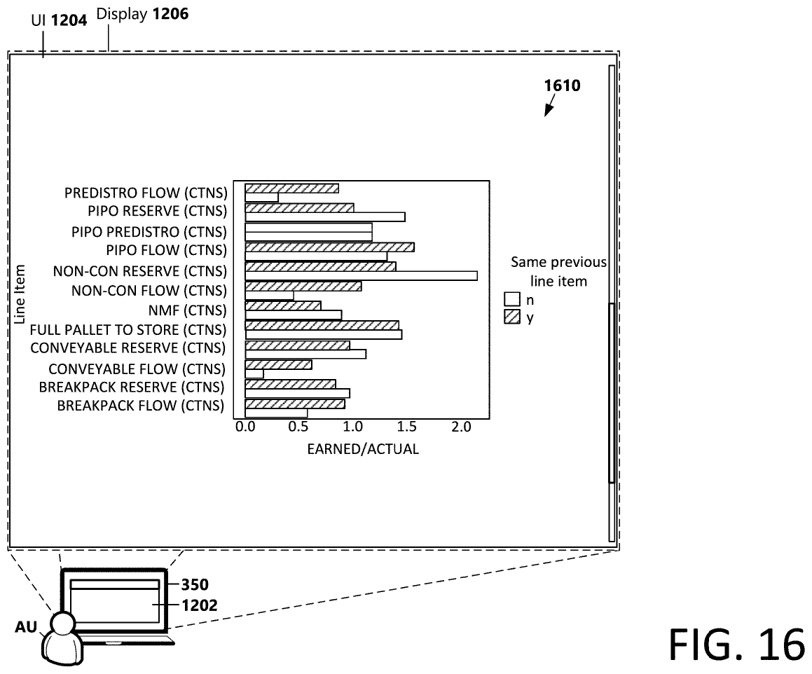

Referring now to FIGS. 12-16, additional example analyses using the enriched dataset for purposes of analyzing workflow performance in a more accurate and finely detailed manner are provided.

FIG. 12 illustrates in examples display window 1202 presentable on a computing device 35 to an administrative user AU, that includes a user interface 1204 presented on a physical display 1206 of the computing device 350. The display window 1202 presents a graph 1210 that illustrates a comparative performance among warehouse or other locations to identify individualized locations where there is a mismatch between goal performance and actual performance. While in this arrangement, the individual location is identifiable, is not generally discernible the reason for the lower performance. That is, such lower performance may be based on changes in material handling between the varying locations, or may be based on differences in process at the varying locations.

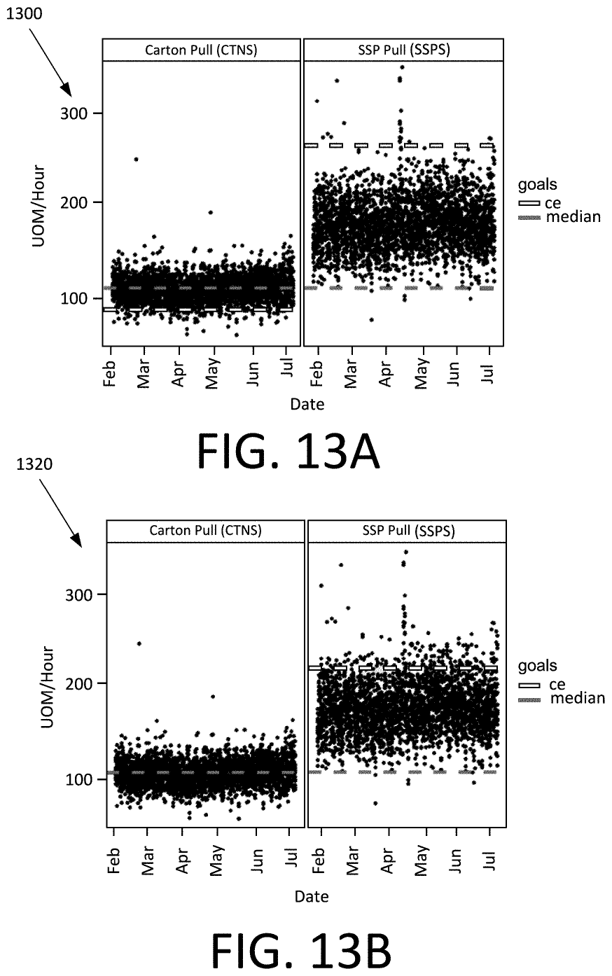

FIGS. 13A-13B illustrate further user interface graphics that may assist in determining the specific causes of such an efficiency. In particular, FIG. 13A illustrates a chart 1300 of productivity on a per hour basis for carton pull and SSP pull tasks, which results in a determined median across both tasks, as well as a common expectation that is set for both tasks which is different from each other. However, as seen in FIG. 13B, a chart 1320 illustrates a modification of the CE for both tasks based on improved data accuracy.

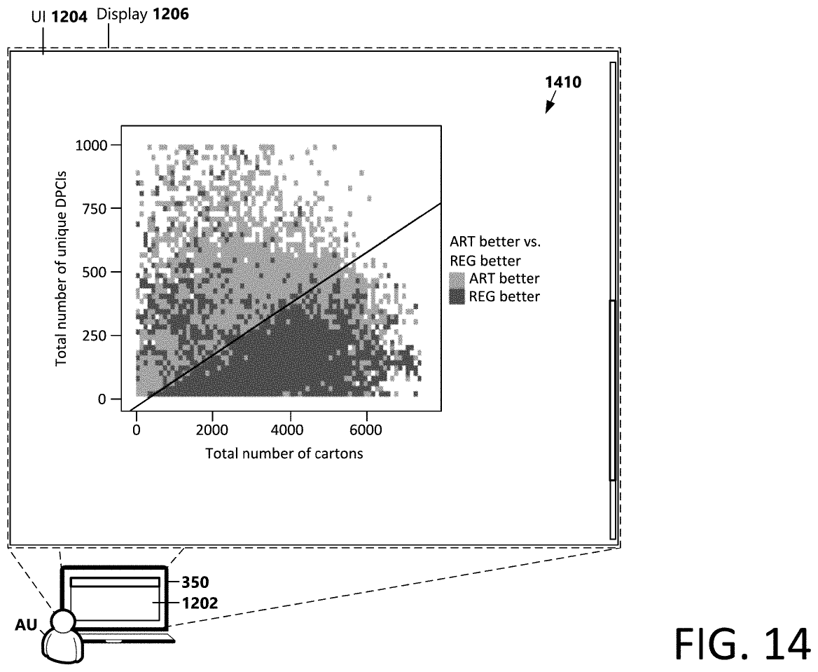

Similarly, FIG. 14 illustrates a further graph 1410 displayable within the user interface 1204 for presenting a comparison between automated dock load/unload processes and manual dock processes at a warehouse. In historical systems this comparison would be performed based on daily volumes. However, as depicted in the graph 1410, a threshold number of items where automated or regular (manual) dock procedures may be performed can be selected based on a specific number of cartons and number of unique items (as defined by their unique item identifiers, or DPCIs). This allows for improved decisionmaking capabilities in terms of selecting a most efficient load handling process at a warehouse based on data having improved granularity at the task level.

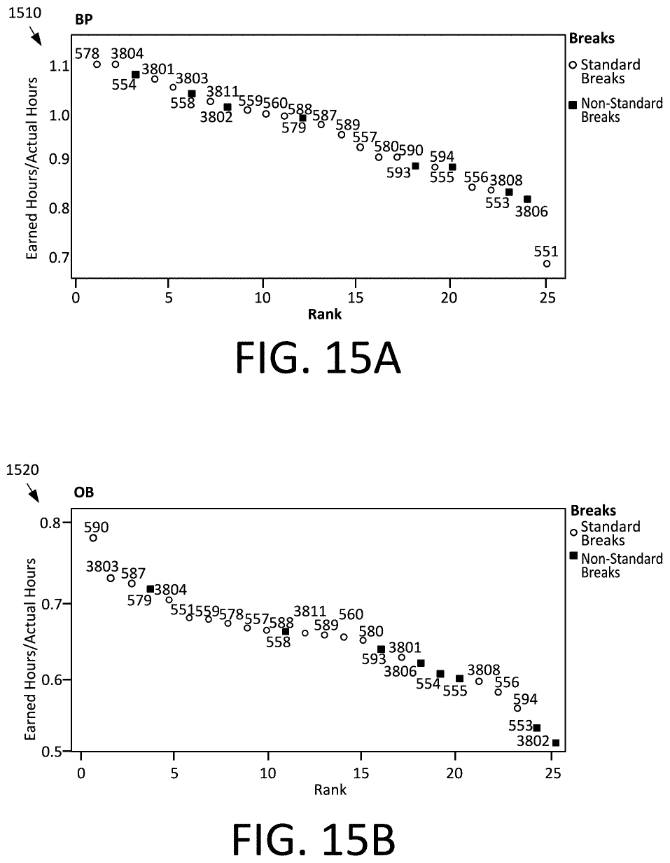

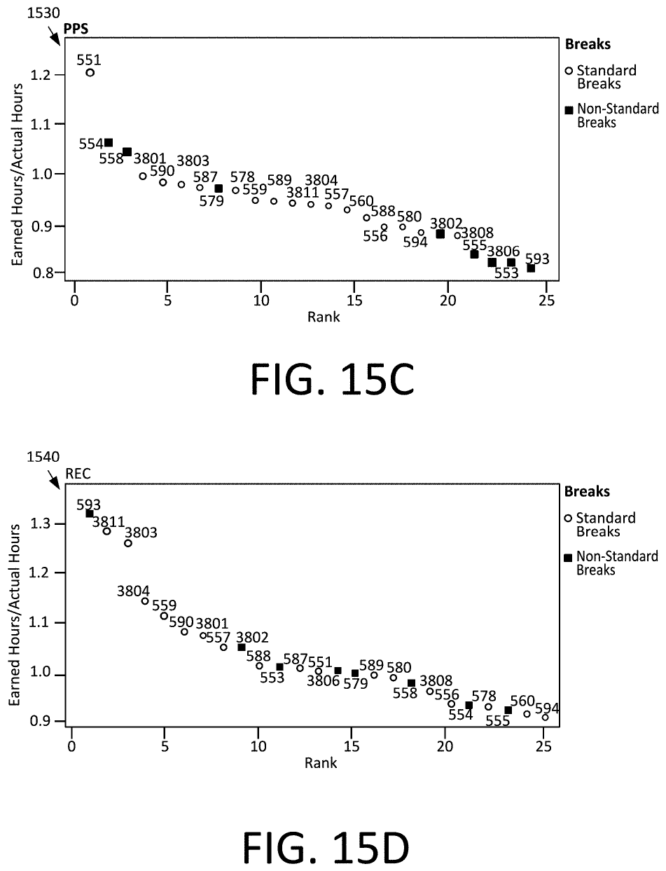

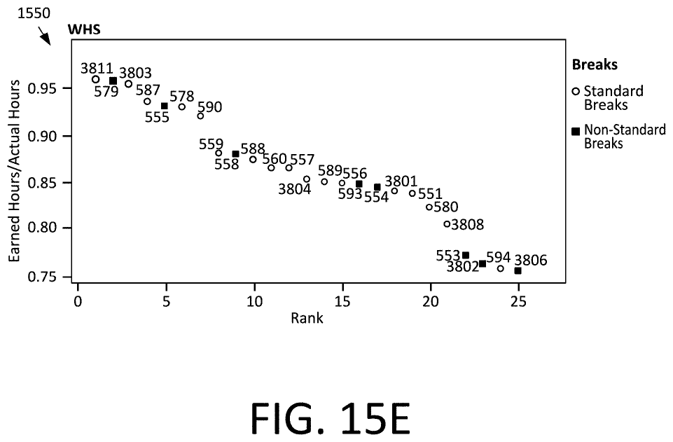

Still further, FIGS. 15A-15E illustrate an analysis that may be performed on task level scan data not based directly on the efficiency of workers with respect to individual item handling, but with respect to other factors that may vary across locations in a supply chain. In particular, an overall performance level of earned vs. actual hours (as measured using fine grained performance data) can be determined for different locations that have different worker paid time off breaks during a shift across a set of tasks. In each of charts 1510, 1520, 1530, 1540, 1550, the non-standard break times (typically shorter than standard) are generally seen as being clustered toward the lower efficiency end of each type of task. Specifically, this appears to trend toward being the case across multiple tasks, including a break pack task seen in FIG. 15A, an outbound task seen in the chart 1520 of FIG. 15B, a PPS task in the chart 1530 of FIG. 15C, a receiving task seen in the chart 1540 of FIG. 15D, and a warehousing task seen in the chart 1550 of FIG. 15E. Each of these charts 1510-1550 may also be depicted within the user interface 1204, but are simply shown in chart form for simplicity.

Finally, in another example chart 1610 able to be displayed within the user interface 1204, a comparative analysis of task efficiency may be performed to determine whether efficiency improves in the case where a previous line item is the same line item as in the current task. That is, the assessment determines whether efficiency gains may be had as to individualized tasks based on, for example, a familiarity with the task or a previously configured set up that allows a worker to operate more efficiently on the subsequent, same item task. It is seen in the chart 1610 that at least some tasks benefit from being the same as a previous line item. Accordingly, planners may adjust to maximize similarity between adjacent line items in these particular circumstances to improve efficiency.

Referring to FIGS. 1-16 generally, although specific types of analyses are shown, it is recognized that the present disclosure is not so limited. Furthermore, it is noted that the systems and methods described herein have a number of advantages over existing approaches for workflow tracking and analysis. In particular, the improved granularity in task level performance data allows for improved accuracy in the analysis of individual tasks within a particular location or across locations within an inventory supply chain. This allows for improved decision-making as well or changes in process flow that can improve the efficiency of the location or the supply chain overall.

The description and illustration of one or more embodiments provided in this application are not intended to limit or restrict the scope of the invention as claimed in any way. The embodiments, examples, and details provided in this application are considered sufficient to convey possession and enable others to make and use the best mode of the claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method of measuring productivity of a task at an enterprise node, the method comprising:
receiving user identifying information including at least a location and a user identification;
receiving user scan-level data of a plurality of events, the scan-level data including an event attribute identifier and a time stamp, wherein the time stamp indicates when an event of a plurality of events began;
determining an end time of each one of the plurality of events, wherein the end time is a presumed start time of a subsequent event;
determining a time period spent on each event;
outputting a dataset including the time period spent on each event, a volume processed by the user at the enterprise node, a total time spend on the plurality of events at the enterprise node, and a volume processed by enterprise node.

2. The method of claim 1, wherein the subsequent event is represented by scan level data from the same user as the event.

3. The method of claim 1, wherein the subsequent event is represented by scan level data associated with a different user.

4. The method of claim 1, wherein the plurality of events are received from the same user.

5. The method of claim 1, further comprising receiving user scan-level data of a plurality of events from a plurality of different users across a plurality of different tasks within the enterprise node.

6. The method of claim 5, further comprising generating at least one analytics user interface depicting relative performance across the plurality of different tasks.

7. The method of claim 6, wherein the plurality of different tasks differ based at least in part on types of items handled or a type of handling performed.

8. The method of claim 6, further comprising:
selecting a location at which common expectations for performance of each of the plurality of different tasks are to be set;
performing a right-sizing of common expectations during a current year for each of the plurality of different tasks based on the dataset including the determined end time or time period;
setting a location-specific performance target; and
applying the location-specific performance target to each of the right sized plurality of different tasks.

9. The method of claim 8, further comprising applying a dilution layer to achieve a predetermined performance target.

10. The method of claim 1, wherein the event comprises a warehouse task event, the warehouse task event being selected from among a pull verification event, a container build event, a load container event, a trailer unload event, a close carton event, an open carton event, a complete pick event, a split event, a receive event, and a put away event.

11. The method of claim 1, further comprising generating a user interface depicting a performance efficiency metric at the task level.

12. A system for analyzing workflow efficiency within an enterprise supply chain node, the system comprising:
a computing system including a data store, a processor, and a memory communicatively coupled to the processor, the memory storing instructions executable by the processor to:
access a dataset including scan level data and enriched data, the dataset including a time period spent on each event of a plurality of events, a volume processed by a user at an enterprise node, a total time spend on the plurality of events at the enterprise node, and a volume processed by enterprise node;
select an enterprise node at which common expectations for performance of each of a plurality of different tasks are to be set from among a plurality of nodes within an enterprise;
perform a right-sizing of common expectations during a current year for each of the plurality of different tasks based on the dataset including the determined end time or time period;
set a location-specific performance target; and
apply the location-specific performance target to each of the right sized plurality of different tasks.

13. The system of claim 12, wherein the instructions further cause the processor to generate the dataset by receiving the scan level data and calculating at least a portion of the enriched data.

14. The system of claim 13, wherein the instructions further cause the processor to:
receive user scan-level data of a plurality of events, the scan-level data including an event attribute identifier and a time stamp, wherein the time stamp indicates when an event of a plurality of events began;
determine an end time of each one of the plurality of events, wherein the end time is a presumed start time of a subsequent event;
determine a time period spent on each event; and
output the dataset.

15. The system of claim 13, further comprising displaying an analysis user interface depicting a chart including at least one scan-level metric, the scan-level metric being a determination of efficiency at a task level within the enterprise node.

16. The system of claim 12, wherein the instructions further cause the processor to generate at least one analytics user interface depicting relative performance across the plurality of different tasks.

17. The system of claim 16, wherein the plurality of different tasks differ based at least in part on types of items handled or a type of handling performed.

18. A non-transitory computer-readable medium comprising computer-executable instructions, which when executed by a computing system cause the computing system to perform:
receiving user identifying information including at least a location and a user identification;
receiving user scan-level data of a plurality of events, the scan-level data including an event attribute identifier and a time stamp, wherein the time stamp indicates when an event of a plurality of events began;
determining an end time of each one of the plurality of events, wherein the end time is a presumed start time of a subsequent event;
determining a time period spent on each event;
outputting a dataset including the time period spent on each event, a volume processed by the user at the enterprise node, a total time spend on the plurality of events at the enterprise node, and a volume processed by enterprise node.

19. The non-transitory computer-readable medium of claim 18, wherein the instructions further cause the computing system to perform:
generating at least one analytics user interface depicting relative performance across a plurality of different tasks reflected in the scan level data.

20. The non-transitory computer-readable medium of claim 19, wherein the instructions further cause the computing system to perform:
selecting a location at which common expectations for performance of each of the plurality of different tasks are to be set;
performing a right-sizing of common expectations during a current year for each of the plurality of different tasks based on the dataset including the determined end time or time period;
setting a location-specific performance target; and
applying the location-specific performance target to each of the right sized plurality of different tasks.
